(19) United States
(12) Patent Application Publication
(10) Pub. No.: US 2022/0076350 A1
(43) Pub. Date: Mar. 10, 2022

(54) ACCOUNTING APPARATUS, REGISTRATION APPARATUS, AND CONTROL METHOD

(71) Applicant: TOSHIBA TEC KABUSHIKI KAISHA, Tokyo (JP)

(72) Inventor: Kentaro HAMADA, Izunokuni Shizuoka (JP)

(21) Appl. No.: 17/315,572

(22) Filed: May 10, 2021

(30) Foreign Application Priority Data
Sep. 9, 2020 (JP) 2020-151461

(51) Int. Cl. G06Q 40/00

(52) U.S. Cl. CPC G06Q 40/12

(57) ABSTRACT

According to an embodiment, an accounting apparatus includes a reader; a memory; an input/output device; and a processor. The memory stores member information read by the reader. The processor causes the input/output device to output information regarding a plurality of handling methods for the member information on a condition that the number of pieces of member information stored in the memory after the reading of the member information by the reader is two or more. The processor receives information regarding selection of one of the plurality of handling methods.

### CROSS-REFERENCE TO RELATED APPLICATIONS

This application is based upon and claims the benefit of priority from the prior Japanese Patent Application No. 2020-151461, filed on Sep. 9, 2020, the entire contents of which are incorporated herein by reference.

### FIELD

An embodiment to be described here generally relates to an accounting apparatus, a registration apparatus, and a control method.

### BACKGROUND

In the past, in a retail store, a restaurant, or the like, in order to secure customers, a specific service is provided to a customer who has become a member. Examples of the member include members unique to stores, members of enterprises that operate a plurality of stores, and members of organizations that span a plurality of companies. When a member conducts a transaction at a store by purchasing a commodity or the like, the member can receive services such as giving points corresponding to money, discounting, issuing coupons, and distributing recommendation information.

In general, member information needs to be input to a point-of-sale (POS) terminal at the time of accounting in order for the member to receive a service. The member information is input to the POS terminal by reading the member information from a member card, a point card, or the like owned by the member by a card reader provided in the POS terminal, for example.

In the above-mentioned POS terminal, because only one piece of member information is received for one transaction, points are given to only one customer when, for example, a plurality of customers goes shopping and accounting is performed collectively. As a solution to this problem, there has been known a method in which a plurality of pieces of member information can be input for one transaction and points can be divided and given to a plurality of members even when a plurality of persons goes shopping and accounting is performed collectively.

However, in the above-mentioned existing technology, it is necessary to input a method of giving points, such as whether or not to divide the points, at the time of accounting. For this reason, for example, even when one person goes shopping, it is necessary to input a method of giving points giving, and the above-mentioned existing technology is not satisfactory in operability.

### BRIEF DESCRIPTION OF THE DRAWINGS

FIG. 1 is a diagram schematically illustrating a POS system according to an embodiment;

FIG. 2 is a perspective view illustrating the external appearance of a POS terminal according to the embodiment;

FIG. 3 is a block diagram illustrating a hardware configuration of the POS terminal according to the embodiment;

FIG. 4 is a diagram illustrating a data configuration of a display screen area in a memory device of the POS terminal according to the embodiment;

FIG. 5 is a diagram illustrating a data configuration of a handling-process area in the memory device of the POS terminal according to the embodiment;

FIG. 6 is a block diagram illustrating a functional configuration of the POS terminal according to the embodiment;

FIG. 7 is a flowchart illustrating a process at the time of payment, which is executed by a controller of the POS terminal according to the embodiment;

FIG. 8 is a flowchart illustrating a member-information handling process executed by the controller of the POS terminal according to the embodiment;

FIG. 9 shows an example of a selection screen for selecting the handling of the member information in the POS terminal according to the embodiment;

FIG. 10 shows another example of the selection screen for selecting the handling of the member information in the POS terminal according to the embodiment;

FIG. 11 is a flowchart illustrating a member-service process executed by the controller of the POS terminal according to the embodiment.

### DETAILED DESCRIPTION

According to an embodiment, an accounting apparatus executes an accounting process relating to transaction data of a commodity for which sales registration has been performed in one transaction. The accounting apparatus includes a reader, an input/output device, a memory, and a processor. The reader reads, from a recording medium of a customer, member information of the customer for identifying a member in the one transaction. The input/output device outputs information regarding a plurality of handling methods for the member information read by the reader and receives selection of one of the plurality of handling methods. The memory stores the member information and the information regarding the plurality of handling methods. The processor receives the read member information and stores the received information in the memory. The processor causes the input/output device to output the information regarding the plurality of handling methods on a condition that the number of pieces of member information stored in the memory after the reading of the member information by the reader is two or more. The processor stores, in the memory, the information regarding the handling method selected via the input/output device. Further, the processor executes, in accordance with the information regarding the handling method stored in the memory after the accounting process, a service process for providing a service to the customer of the member identified by the member information stored in the memory.

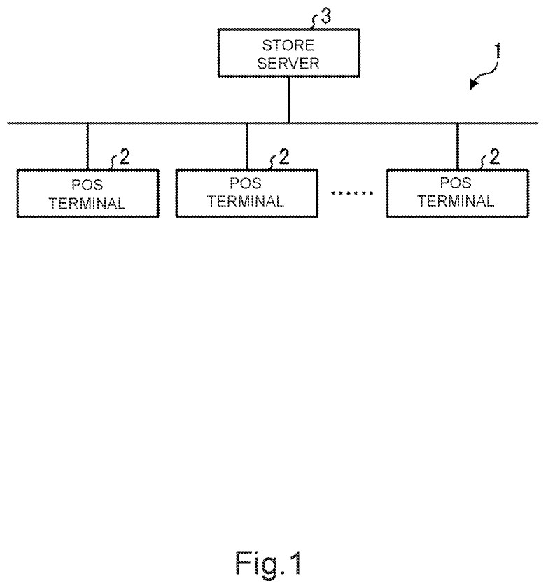

Hereinafter, a POS system according to an embodiment will be described with reference to the drawings. The same reference symbols in the drawings denote the same or similar portions. FIG. 1 is a schematic diagram illustrating the POS system according to the embodiment. A POS system 1 is a system for executing a sales process of commodities sold in a store, sales management, and the like, and is installed in a retail store in this embodiment. However, the embodiment is not limited thereto, and the POS system 1 is applicable to other fields such as restaurants and hotels. The POS system 1 includes one or more POS terminals 2 installed in the store and a store server 3 installed in the backyard of the store. The POS terminal 2 and the store server 3 are connected to each other via a communication line such as a local area network (LAN). This allows the POS terminal 2 and the store server 3 to communicate with each other and transmit/receive information to/from each other.

In a transaction with a customer, the POS terminal 2 executes sales registration of a commodity purchased by the customer (hereinafter, referred to also as commodity registration) and an accounting process relating to transaction data of the commodity for which commodity registration has been performed. Note that the commodity is a concept including a service. The commodity registration includes storing commodity information (commodity names, prices, etc.) in a storage device on the basis of a commodity code input to the POS terminal 2. Further, the accounting process includes a process executed by the POS terminal 2 on the basis of transaction data such as commodity information regarding the purchased commodity in order for the customer to pay the price. The accounting process includes, for example, calculation of a transaction amount based on commodity information of the commodity for which commodity registration has been performed, calculation of a change amount with respect to a deposit deposited from a customer, displaying of various types of information such as a transaction amount and a change amount, and issuing instructions for receipts to printers.

As described above, the POS terminal 2 has a function of a registration apparatus that performs sales registration of commodities and a function of an accounting apparatus that performs an accounting process relating to transaction data. Thus, the POS terminal 2 is an example of the registration apparatus and an example of the accounting apparatus. Note that the POS system 1 may be a so-called semi-self type POS system in which a registration apparatus and an accounting apparatus are separately provided.

The store server 3 receives, from the respective POS terminals 2, commodity information and payment information of the paid commodity in the accounting process. Further, the store server 3 receives, from the respective POS terminals 2, settlement information regarding settlement of sales for a predetermined period (e.g., one day). The store server 3 centrally manage the commodity information, the payment information, the settlement information, and the like received from the respective POS terminals 2 to perform sales management in one store.

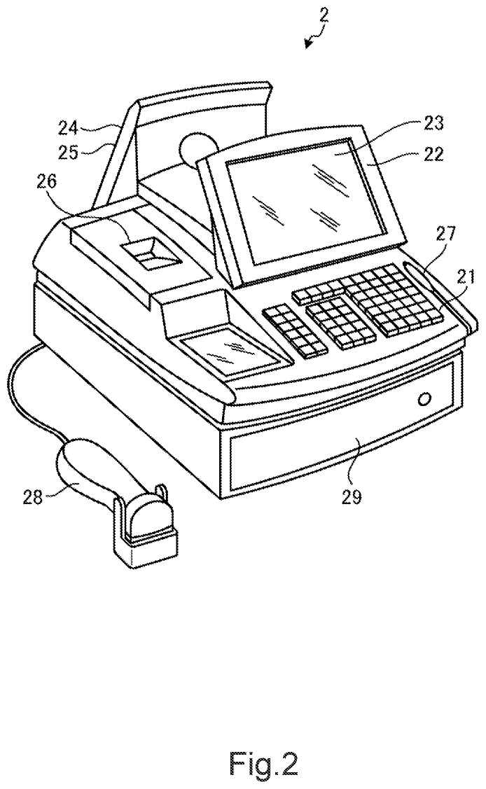

Next, the configuration of the POS terminal 2 will be described. FIG. 2 is a perspective view illustrating the external appearance of the POS terminal 2. The POS terminal 2 includes a keyboard 21, an operator display 22, an operator touch panel 23, a customer display 24, a customer touch panel 25, a printer 26, a card reader 27, a scanner 28, a money storage 29, and the like.

The keyboard 21 includes various keys. The various keys include, for example, a selection key for selecting a payment method such as credit card payment, a transaction start key for declaring the start of a transaction, a number key for inputting a commodity code, the amount of money, and the like, a sub-total key for declaring the calculation of the total amount of sales (accounting-process start key), a closing key for declaring the payment of the price by executing the closing process of one transaction, and a clear key for clearing the input.

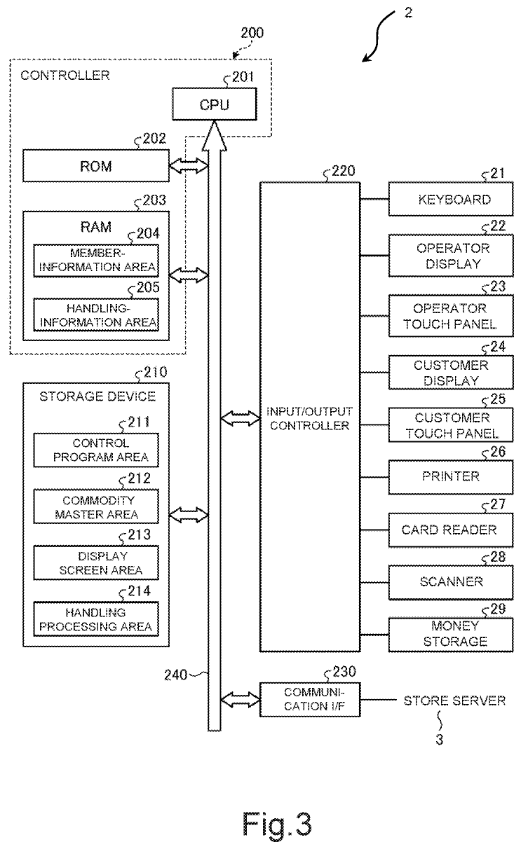

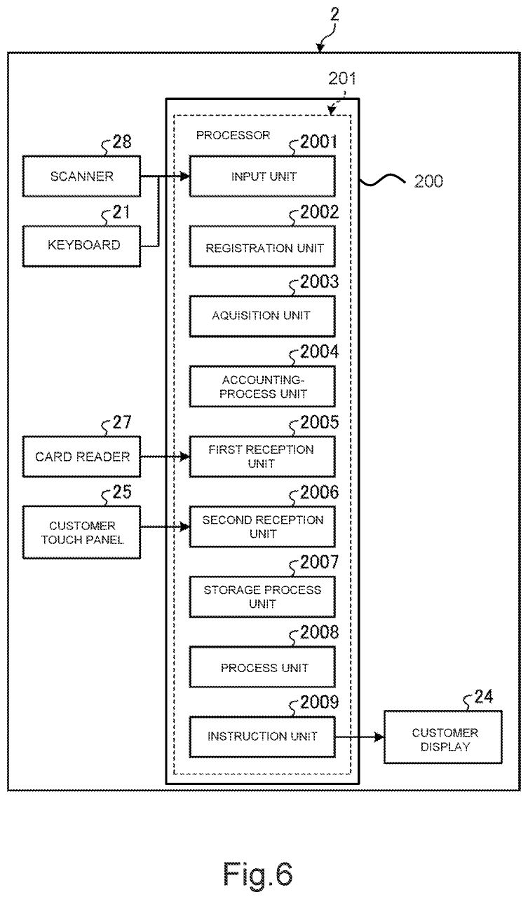

The operator display 22 includes a liquid crystal panel or the like, and displays the commodity information, the accounting information, and the like to an operator who operates the POS terminal 2. Note that the accounting information includes information relating to the accounting process, such as the transaction amount and the change amount. The operator touch panel 23 is provided on the operator display 22, and inputs information corresponding to a position touched by the operator to a controller (see FIG. 3 and FIG. 6), which will be described below, of the POS terminal 2.

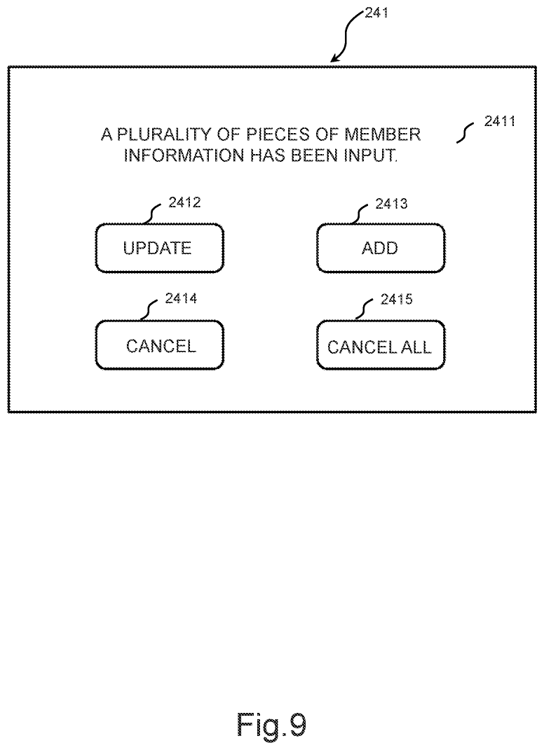

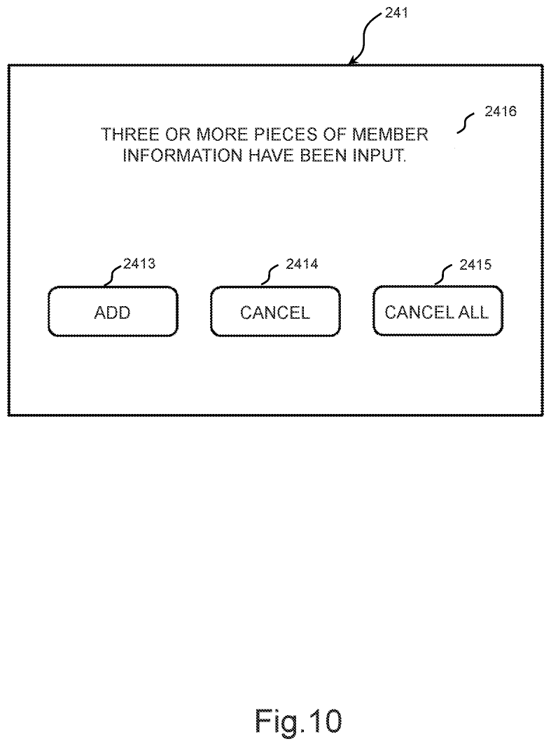

The customer display 24 has a configuration similar to that of the operator display 22. That is, the customer display 24 includes a liquid crystal panel or the like, and displays the commodity information, the accounting information, and the like to the customer who purchases a commodity. The customer display 24 displays also a selection screen (see FIG. 9 and FIG. 10) for a method of handing member information described below. The customer display 24 is an example of a display device for displaying the selection screen, in other words, an example of an input/output device for prompting the customer to input information relating to the method of handling the member information. The customer touch panel 25 is provided on the surface of the customer display 24, and inputs information corresponding to a position touched by the customer to the controller of the POS terminal 2.

The printer 26 is, for example, a thermal printer. The printer 26 prints the commodity information, the accounting information, and the like on a roll-like receipt sheet housed in the POS terminal 2 and issues it as a receipt.

The card reader 27 magnetically reads, from the recording medium such as the member card and the point card presented by the customer, the member information for identifying the member. Further, the card reader 27 magnetically reads, from the credit card, credit information necessary for payment. Note that the card reader 27 may be an IC card reader that reads information from a card including a built-in IC chip.

The scanner 28 optically recognizes a code symbol such as a bar code attached to a commodity purchased by a customer or recognizes a code symbol by capturing an image of the code symbol. The scanner 28 decodes the recognized code symbol to read the commodity code indicated by the code symbol. Note that the controller of the POS terminal 2 may decode the code symbol recognized by the scanner 28.

The money storage 29 includes a drawer inside for receiving coins and bills, and receives money deposited from customers, securities such as gift certificates, and change to be given to customers. The money storage 29 is opened by an instruction of the controller of the POS terminal 2 so that the drawer for receiving the money is exposed.

FIG. 3 is a block diagram illustrating a hardware configuration of the POS terminal 2. The POS terminal 2 includes a controller 200, a storage device 210, an input/output controller 220, a communication interface (I/F) 230, and the like. The controller 200, the storage device 210, the input/output controller 220, and the communication I/F 230 are connected to each other via a bus 240.

The controller 200 includes a computer including a processor 201 and memories 202 and 203. The processor 201 is, for example, a central processing unit (CPU). Each of the memories 202 and 203 includes a read only memory (ROM) 202, and a random access memory (RAM) 203.

The processor 201 controls the operation of the entire POS terminal 2. The ROM 202 stores various programs such as programs used to drive the processor 201, and various types of data. As shown in FIG. 3, the RAM 203 includes a member-information area 204 and a handling-information area 205. In one transaction, the member-information area 204 temporarily stores the member information read by the card reader 27 in association with the reading order during a period from the start of the transaction to the end of the commodity registration and the start of the accounting process (hereinafter, referred to as the reading period). The handling-information area 205 temporarily stores, in the case where a plurality of pieces of member information is read by the card reader 27 during the reading period of the member information by the card reader 27, information indicating the method of handling the member information selected by the customer. Further, the RAM 203 temporarily stores the commodity information acquired in the sales registration, and the like. Further, the RAM 203 is used as a work area of the processor 201 and expands various programs and various types of data stored in ROM 202 and the storage device 210. The controller 200 executes various control processes of the POS terminal 2 when the processor 201 operates in accordance with the control program that is stored in the ROM 202 or the storage device 210 and expanded into the RAM 203.

The storage device 210 includes, for example, rewritable non-volatile storage medium such as a hard disk drive (HDD), a solid state memory (SSD), and a flush memory. As shown in FIG. 3, the storage device 210 includes a control program area 211, a commodity master area 212, a display screen area 213, and a handling-process area 214. The control program area 211 stores the control program for the POS terminal 2 to function as well as various control programs.

The commodity master area 212 stores a commodity master. The commodity master represents a master file in which commodity codes and commodity information (commodity names, prices, etc.) are stored in association with each other for commodities handled in a store. Because the commodities handled in the store change every day, the commodity master is appropriately updated by the store server 3 connected via the communication I/F 230.

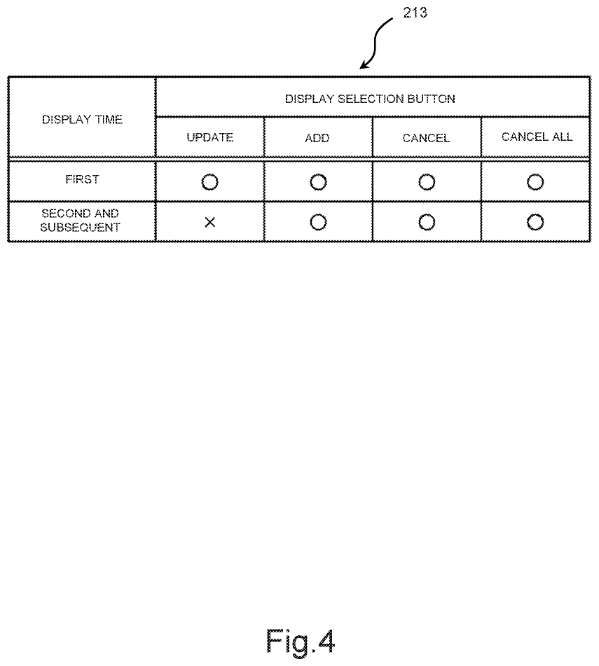

The display screen area 213 stores, in the case where a plurality of pieces of member information is read by the card reader 27 during the reading period, data for displaying the selection screen of the method of handling the member information on the customer display 24. FIG. 4 is a diagram illustrating a data configuration of the display screen area 213. The display screen area 213 stores display times during accounting of one transaction (hereinafter, referred to also as “during the transaction”) and display selection buttons displayed on the corresponding display time in association with each other.

The display time represents information indicating how many times the selection screen is displayed during the transaction. The display selection button represents information indicating the type of the selection button (see FIG. 9 and FIG. 10) displayed on the selection screen, which will be described below. The selection screen is a screen displayed on a condition that a plurality of pieces of member information is input during the reading period. Therefore, the selection screen displayed in the case where the second member information is input during the reading period is the first selection screen. Further, the selection screen displayed in the case where three or more pieces of member information are input is the second and subsequent selection screens.

In this embodiment, when the second member information is input to the POS terminal 2 during the reading period, the customer display 24 performs display (see FIG. 9) including four selection buttons of “Update”, “Add”, “Cancel” and “Cancel all” as the first selection screen in accordance with the data of the display screen area 213 shown in FIG. 4. Further, when the third and subsequent pieces of member information are input to the POS terminal 2 during the reading period, the customer display 24 displays (see FIG. 10) three selection buttons of “Add”, “Cancel”, and “Cancel all” as the second and subsequent selection screens in accordance with the data of the display screen area 213 shown in FIG. 4.

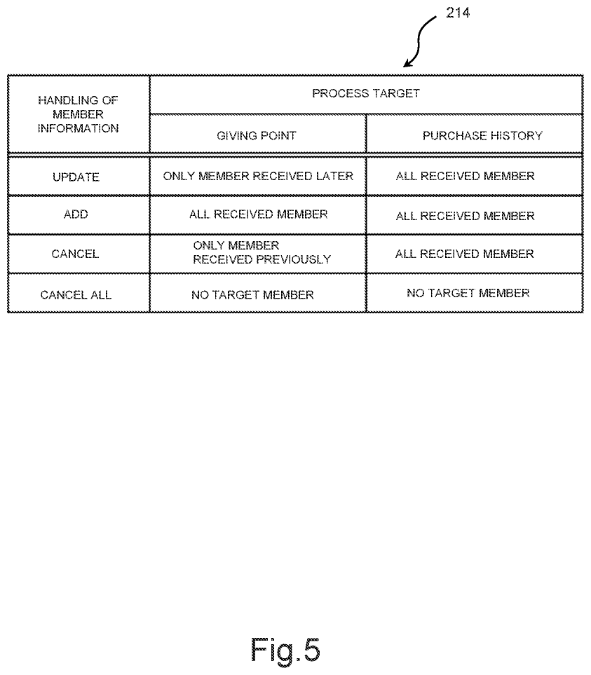

The handling-process area 214 stores the process target of the POS terminal 2 for the method of handling the member information selected by the customer. FIG. 5 is a diagram illustrating a data configuration of the handling-process area 214. The handling-process area 214 stores the handling of the member information and the process target in association with each other.

The handling of the member information indicates the method of handling the member information in the case where the second or subsequent member information is input to the POS terminal 2, and can be selected by the customer by the displayed selection button.

The process target is information for specifying the member to be processed for each process relating to the service to be provided to the member (hereinafter, referred to as the “member-service process”). In this embodiment, the member-service process executed by the POS terminal 2 includes a process for giving points to members (hereinafter, referred to also as the “point process”) and a process for storing purchase histories (hereinafter, referred to also as the “purchase-history process”).

Examples of the point process executed by the POS terminal 2 include calculation of a given point based on a transaction amount of one transaction, transmission of the given point to the store server 3, and instructing the printer 26 to print the given point. Examples of the purchase-history process executed by the POS terminal 2 include transmission of purchase information of one transaction to the store server 3. By storing the purchase history in the store server 3 or the like, it is possible to execute a service for the member, such as issuing coupons and recommendation transmission. For this reason, the purchase-history process can be referred to as an example of a process relating to a service to be provided to the member. Note that the process relating to the service to be provided to the member is not limited to the process described above.

When “Update” is selected by the customer, i.e., when an update button 2412 (see, for example, FIG. 9) is operated, the point process is executed only for the member identified by the member information input later as shown in FIG. 5. Further, the purchase-history process is executed for all members identified by the input member information.

When “Add” is selected by the customer, i.e., when an add button 2413 (see, for example, FIG. 9) is operated, the point process and the purchase-history process are executed for all members identified by the input member information as shown in FIG. 5. In this case, the point process may be performed by equally dividing the given points calculated on the basis of the transaction amount of one transaction for the target members, or by dividing the given points in accordance with the request of the customer. Alternatively, the above-mentioned given points may be given to each of the members, and the method of giving the points can be appropriately set by the store.

When the “Cancel” is selected by the customer, i.e., when a cancel button 2414 (see, for example, FIG. 9) is operated, the point process is executed only for the member identified by the previously input member information as shown in FIG. 5. Further, the purchase-history process is executed for all members identified by the input member information.

When “Cancel all” is selected by the customer, i.e., when a cancel-all button 2415 (see, for example, FIG. 9) is operated, the point process and the purchase-history process are not executed for all members identified by the input member information. For example, when “Cancel all” is selected, all pieces of member information stored in the member-information area 204 of the RAM 203 during the reading period are deleted. Note that when new member information is input after “Cancel all” is selected, the POS terminal 2 is capable of executing the point process and the purchase-history process for the member identified by the member information.

Now, description is made with reference to FIG. 3 again. The input/output controller 220 is connected to the keyboard 21, the operator display 22, the operator touch panel 23, the customer display 24, the customer touch panel 25, the printer 26, the card reader 27, the scanner 28, and the money storage 29. The input/output controller 220 has a function as an input/output interface to the connected hardware and a function for controlling the hardware. As a result, the controller 200 is capable of transmitting/receiving information (data) to/from the keyboard 21, the operator display 22, the operator touch panel 23, the customer display 24, the customer touch panel 25, the printer 26, the card reader 27, the scanner 28, and the money storage 29 via the input/output controller 220. Further, the controller 200 is capable of controlling the hardware on the basis of the instructions of the hardware.

The communication I/F 230 is an interface for communicating with the store server 3. The controller 200 is capable of transmitting/receiving information (data) to/from the store server 3 by being connected to the store server 3 via the communication I/F 230.

Next, the functional configuration of the POS terminal 2 will be described. FIG. 6 is a block diagram illustrating a functional configuration of a POS terminal. The processor 201 of the controller 200 operates in accordance with the control program stored in the ROM 202 and the control program area 211 of the storage device 210, thereby functioning as an input unit 2001, a registration unit 2002, an acquisition unit 2003, an accounting-process unit 2004, a first reception unit 2005, a second reception unit 2006, a storage-process unit 2007, a process unit 2008, and an instruction unit 2009. Note that each of these functions may be realized by hardware.

The input unit 2001 inputs a commodity code from the scanner 28 or the keyboard 21 which is an input device of a commodity code. For example, the input unit 2001 inputs a commodity code read by the scanner 28 from a bar code attached to the commodity. Further, the input unit 2001 inputs, via the keyboard 21, the commodity code of a commodity to which no bar code is attached. Further, the input unit 2001 inputs a transaction-start signal indicating the start of one transaction, an accounting-process signal for instructing the start of the accounting process, and the like from the keyboard 21.

The registration unit 2002 registers the sales of the commodity to be traded. Specifically, the registration unit 2002 refers to the commodity master area 212 on the basis of the commodity code input to the input unit 2001 to acquire commodity information (commodity names, prices, etc.). The registration unit 2002 temporarily stores the acquired commodity information in the RAM 203. That is, the registration unit 2002 performs commodity registration.

The acquisition unit 2003 acquires transaction data relating to one transaction. Specifically, the acquisition unit 2003 acquires, from the RAM 203, the commodity information or the like stored by the registration unit 2002. The commodity information including prices is an example of the transaction data. Note that in a self POS terminal where a registration apparatus for performing commodity registration is separately provided, the acquisition unit 2003 acquires transaction data from the registration apparatus.

The accounting-process unit 2004 executes an accounting process relating to transaction data acquired by the acquisition unit 2003. Specifically, the accounting-process unit 2004 calculates a total amount (transaction amount) of commodities for which commodity registration has been performed, calculates a change amount, instructs the operator display 22 and the customer display 24 to display various types of information, and instructs the printer 26 to issue a receipt.

The first reception unit 2005 receives member information for identifying a member. Specifically, the first reception unit 2005 receives, from the card reader 27, the member information (member ID) read by the card reader 27. In other words, the first reception unit 2005 can be referred to as a member-information reception unit.

The second reception unit 2006 receives information indicating the method of handling the member information. Specifically, the second reception unit 2006 receives, via the selection screen (see FIG. 9 and FIG. 10) displayed on the customer display 24, pieces of information indicating “Update”, “Add”, “Cancel”, and “Cancel all”, which are the methods of handling the member information. In other words, the second reception unit 2006 can be referred to as a member-information-handling reception unit.

The storage-process unit 2007 stores, in the member-information area 204 of the RAM 203, the member information received by the first reception unit 2005 in one transaction in association with the received order. Further, the storage-process unit 2007 stores, on the basis of the information received by the second reception unit 2006, information indicating the handling of the member information in the handling-information area 205 of the RAM 203. Further, the storage-process unit 2007 deletes, when the second reception unit 2006 receives information indicating “Cancel all”, the member information stored in the member-information area 204.

The process unit 2008 executes a process relating to a service to be provided to the member identified by the member information received by the first reception unit 2005. Specifically, the process unit 2008 executes the above-mentioned point process, purchase-history process, and the like on the basis of the member information stored in the member-information area 204 of the RAM 203 and the information stored in the handling-information area 205 at the time point of executing the process.

The instruction unit 2009 outputs information for causing the customer to select a method of handling the member information for the process of the process unit 2008 on a condition that the first reception unit 2005 has received a plurality of pieces of different member information for one transaction. That is, the instruction unit 2009 functions as an output control unit that outputs the information. Specifically, the instruction unit 2009 instructs to display a selection screen for causing the customer to select a method of handling the member information received later by the first reception unit 2005, on a condition that the first reception unit 2005 has received a plurality of pieces of different member information during the reading period. That is, the instruction unit 2009 transmits, to the customer display 24, an instruction signal for instructing to display the selection screen.

In this embodiment, the input/output device performs an output for prompting the customer to input a method of handling the member information for the process of the process unit 2008. As an example of the input/output device, the customer display 24 displays the selection screen (see FIG. 9 and FIG. 10). However, the embodiment is not limited thereto. For example, the customer display 24 or the operator display 22 may display only a message of “A plurality of pieces of member information has been input. How do you want to handle the member information?”. Further, this message may be output by voice. In this case, the operator only needs to listen to the method of handling the member information from the customer, and input information indicating the method of handling the member information to the POS terminal 2.

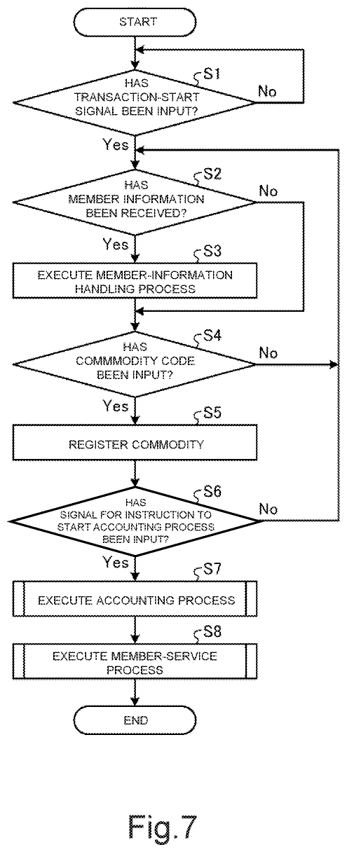

Next, the operation of the POS terminal 2 based on the above-mentioned configuration will be described. FIG. 7 is a flowchart illustrating a process executed by the processor 201 of the controller 200 at the time of payment performed by the customer.

In Step S1 of FIG. 7, the input unit 2001 of the processor 201 determines whether or not a transaction-start signal indicating the start of one transaction has been input from the keyboard 21. In the case where it is determined that the transaction-start signal has not been input (No in Step S1), the process of the processor 201 returns to Step S1 and stands by. In the case where the operator operates the transaction start key of the keyboard 21 and it is determined that the transaction-start signal has been input from the keyboard 21 (Yes in Step S1, the process of the processor 201 proceeds to Step S2. In Step S2, the first reception unit 2005 of the processor 201 determines whether or not member information has been received.

For example, in the case where the card reader 27 reads the member information from the member card of the customer and it is determined that the member information has been received from the card reader 27 (Yes in Step S2), the process of the processor 201 proceeds to Step S3. In Step S3, the processor 201 executes a member-information handling process. The member-information handling process will be described in detail below.

Subsequently, in Step S4, the input unit 2001 of the processor 201 determines whether or not a commodity code has been input. In the case where it is determined that the commodity code has not been input (No in Step S4), the process of the processor 201 returns to Step S2. For example, in the case where the commodity code is read by the scanner and it is determined that the commodity code has been input (Yes in Step S4), the process of the processor 201 proceeds to Step S5. In Step S5, the registration unit 2002 of the processor 201 performs commodity registration for the commodity identified by the commodity code. Note that in Step S2, in the case where it is determined that the member information has not been received from the card reader 27 (No in Step S2), the process of the processor 201 skips Step S3 and proceeds to Step S4.

Subsequent to the commodity registration in Step S5, the input unit 2001 of the processor 201 determines in Step S6 whether or not a signal for instructing to start the accounting process has been input. In the case where it is determined that the signal for instructing to start the accounting process has not been input (No in Step S6), the process of the processor 201 returns to Step S2. In the case where all the commodities purchased by the customer have been registered, the operator has operated the sub-total key of the keyboard 21, and it is determined that a signal for instructing to start the accounting process has been input from the keyboard 21 (Yes in Step S6), the process of the processor 201 proceeds to Step S7. In Step S7, the accounting-process unit 2004 of the processor 201 executes the accounting process. Subsequently, in Step S8, the process unit 2008 of the processor 201 executes the member-service process. Thus, the processor 201 ends the process shown in FIG. 7. Note that the content of the accounting process in Step S7 is as described above. The member-service process in Step S8 will be described below.

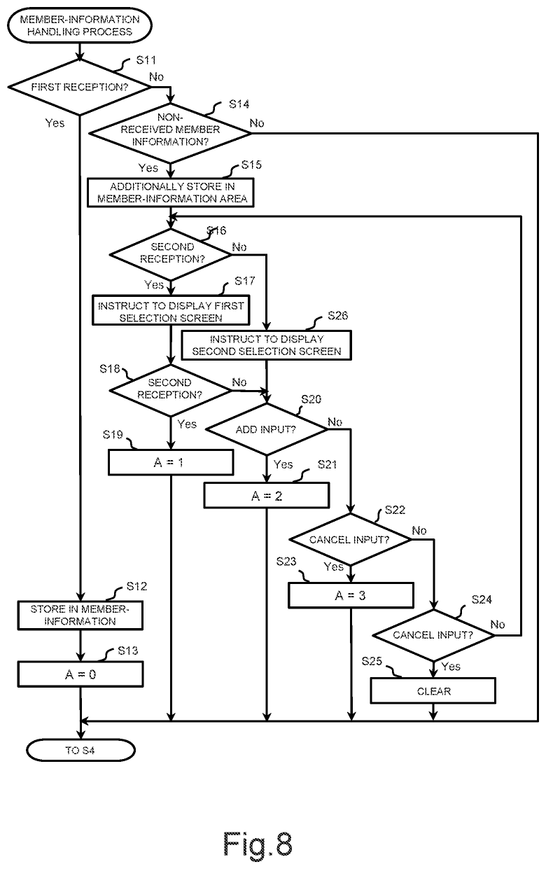

Next, the member-information handling process will be described in detail. FIG. 8 is a flowchart illustrating the member-information handling process executed by the processor 201 of the controller 200.

The member-information handling process is executed in the case where the first reception unit 2005 of the processor 201 has received member information (see Step S3 in FIG. 7). First, in Step S11 in FIG. 8, the first reception unit 2005 of the processor 201 determines whether or not the reception of the member information is the first reception. That is, the first reception unit 2005 of the processor 201 determines whether or not the received member information has been received for the first time during the reading period.

In the case where it is determined that the reception of the member information is the first reception (Yes in Step S11), the process of the processor 201 proceeds to Step S12. In Step S12, the storage-process unit 2007 of the processor 201 stores the received member information in the member-information area 204 of the RAM 203. In Step S13, the storage-process unit 2007 of the processor 201 stores “A=0” in the handling-information area 205 of the RAM 203 as information indicating that the reception of the member information stored in the member-information area 204 is the first reception. Then, the process of the processor 201 proceeds to Step S4 in FIG. 7.

Note that in the case where it is determined in Step S11 that the reception of the member information is not the first reception (No in Step S11), the process of the processor 201 proceeds to Step S14. In Step S14, the processor 201 determines whether or not the received member information is the member information that has been previously received during the reading period. In the case where it is determined that the received member information is the member information that has been previously received during the reading period, i.e., in the case where the received member information is not the non-received member information (No in Step S14), the process of the processor 201 proceeds to Step S4 in FIG. 7.

Meanwhile, in the case where it is determined that the received member information is member information that has not been received during the reading period, i.e., in the case where the received member information is non-received member information (Yes in Step S14), the process of the processor 201 proceeds to Step S15. In Step S15, the storage-process unit 2007 of the processor 201 additionally stores the non-received member information in the member-information area 204 of the RAM 203. Next, in Step S16, the processor 201 determines whether or not the reception of the member information is the second reception of the member information during the reading period. In other words, the first reception unit 2005 of the processor 201 determines whether or not the received member information is the second member information received during the reading period.

In the case where it is determined that the reception of the member information is the second reception of the member information during the reading period (Yes in Step S16), the process of the processor 201 proceeds to Step S17. In Step S17, the instruction unit 2009 of the processor 201 outputs an instruction signal to display the first selection screen 241 on the customer display 24. FIG. 9 shows a display example of the first selection screen 241 on the customer display 24. The first selection screen 241 is displayed on the customer display 24 in the case where the first reception unit 2005 receives two pieces of different member information. For example, on the first selection screen 241, a message of “A plurality of pieces of member information has been input. How do you want to handle the member information?” and the four selection buttons of the update button 2412, the add button 2413, the cancel button 2414, and the cancel-all button 2415 are displayed. The content indicated by the selection buttons 2412 to 2415 is as described above. By touching one of the displayed selection buttons 2412 to 2415, the method of handling the member information received later by the first reception unit 2005 can be selected.

Now, description is made with reference to FIG. 8 again. Subsequent to the process in Step S17, the second reception unit 2006 of the processor 201 determines in Step S18 whether or not an “update” input has been received from the customer touch panel 25. In other words, the processor 201 determines whether or not the “Update” selection button 2412 displayed on the customer display 24 has been selected by the customer. In the case where it is determined that the “update” input has been received from the customer touch panel 25 (Yes in Step S18), the process of the processor 201 proceeds to Step S19. In Step S19, the storage-process unit 2007 of the processor 201 stores “A=1” in the handling-information area 205 of the RAM 203 as information indicating that the “update” input has been performed. Then, the process of the processor 201 proceeds to Step S4 in FIG. 7.

Meanwhile, in the case where it is determined in Step S18 that the “update” input has not been received from the customer touch panel 25 (No in Step S18), the process of the processor 201 proceeds to Step S20. In Step S20, the second reception unit 2006 of the processor 201 determines whether or not an “add” input has been received from the customer touch panel 25. In other words, the processor 201 determines whether or not the “Add” selection button 2413 displayed on the customer display 24 has been selected by the customer. In the case where it is determined that the “add” input has been received from the customer touch panel 25 (Yes in Step S20), the process of the processor 201 proceeds to Step S21. In Step S21, the storage-process unit 2007 of the processor 201 stores “A=2” in the handling-information area 205 as information indicating that the “add” input has been performed. Then, the process of the processor 201 proceeds to Step S4 in FIG. 7.

Meanwhile, in the case where it is determined in Step S20 that the “add” input has not been received from the customer touch panel 25 (No in Step S20), the process of the processor 201 proceeds to Step S22. In Step S22, the second reception unit 2006 of the processor 201 determines whether or not a “cancel” input has been received from the customer touch panel 25. In other words, the processor 201 determines whether or not the “Cancel” selection button 2414 displayed on the customer display 24 has been selected by the customer. In the case where it is determined that the “cancel” input has been received from the customer touch panel 25 (Yes in Step S22), the process of the processor 201 proceeds to Step S23. In Step S23, the storage-process unit 2007 of the processor 201 stores “A=3” in the handling-information area 205 as information indicating that the “cancel” input has been performed. Then, the process of the processor 201 proceeds to Step S4 in FIG. 7.

Meanwhile, in the case where it is determined in Step S22 that the “cancel” input has not been received from the customer touch panel 25 (No in Step S22), the process of the processor 201 proceeds to Step S24. In Step S24, the second reception unit 2006 of the processor 201 determines whether or not the “Cancel all” input has been received from the customer touch panel 25. In other words, the processor 201 determines whether or not the “Cancel all” selection button 2415 displayed on the customer display 24 has been selected by the customer. In the case where it is determined that the “cancel all” input has been received from the customer touch panel 25 (Yes in Step S24), the process of the processor 201 proceeds to Step S25. In Step S25, the storage-process unit 2007 of the processor 201 deletes and clears the information stored in the member-information area 204 and the handling-information area 205 of the RAM 203. Then, the process of the processor 201 proceeds to Step S4 in FIG. 7. Meanwhile, in the case where it is determined in Step S24 that the “cancel all” input has not been received from the customer touch panel 25 (No in Step S24), the process of the processor 201 returns to Step S16.

Further, in the case where it is determined in Step S16 that the reception of the member information is not the second reception of the member information during the reading period (No in Step S16), i.e., in the case where three or more pieces of different member information have been received during the reading period, the process of the processor 201 proceeds to Step S26. In Step S26, the instruction unit 2009 of the processor 201 outputs an instruction signal to display the second selection screen on the customer display 24, and the process of the processor 201 proceeds to Step S20 described above. FIG. 10 shows a display example of the second selection screen 242 on the customer display 24. The second selection screen 242 is displayed on the customer display 24 in the case where the first reception unit 2005 receives three or more pieces of different member information. On the second selection screen 242, for example, a message of “Three or more pieces of member information have been input. How do you want to handle the member information?” and the three selection buttons of the add button 2413, the cancel button 2414, and the cancel-all button 2415 described above are displayed. Through such a member-information handling process, the first reception unit 2005 of the processor 201 sets the method of handling the member information received later.

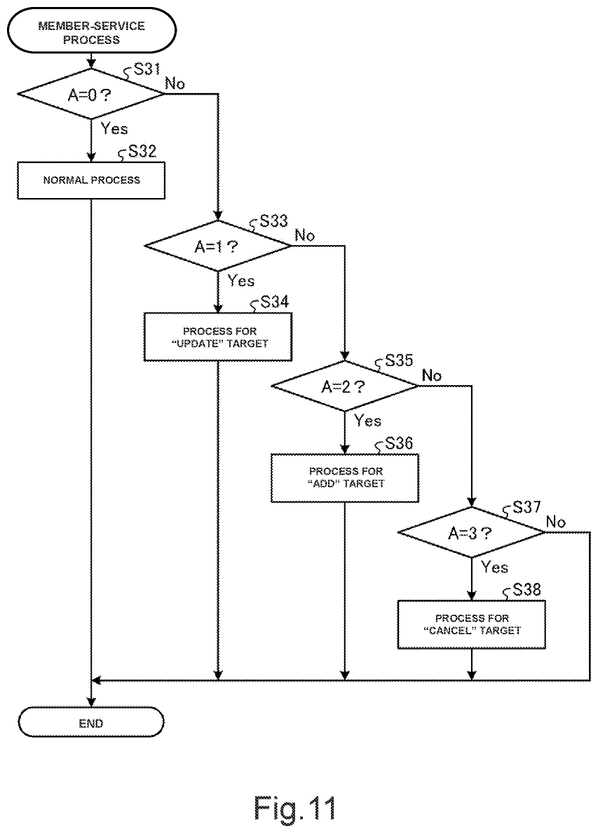

Next, the member-service process will be described in detail. FIG. 11 is a flowchart illustrating the member-service process executed by the processor 201 of the controller 200.

In the member-service process executed after the accounting process (see Step S7 shown in FIG. 7), first, the processor 201 refers to the handling-information area 205 of the RAM 203 to determine whether or not “A=0” (see Step S13 in FIG. 8) is stored as the information indicating the method of handling the member information in Step S31. That is, the first reception unit 2005 of the processor 201 determines whether or not the number of pieces of member information received during the reading period is only one.

In the case where it is determined that “A=0” is stored in the handling-information area 205 (Yes in Step S31), the process of the processor 201 proceeds to Step S32. In Step S32, the process unit 2008 of the processor 201 executes a normal member-service process, i.e., a member-service process for the member identified by the member information stored in the member-information area 204. Then, the processor 201 ends the member-service process in FIG. 11.

Meanwhile, in Step S31, in the case where it is determined that “A=0” is stored in the handling-information area 205 of the RAM 203 (No in Step S31), the process of the processor 201 proceeds to Step S33. In Step S33, the processor 201 determines whether or not “A=1” is stored in the handling-information area 205 of the RAM 203. In the case where it is determined that “A=1” is stored in the handling-information area 205 (Yes in Step S33), the process of the processor 201 proceeds to Step S34. In Step S34, the process unit 2008 of the processor 201 refers to the handling-process area 214 shown in FIG. 5, and executes the member-service process for the target member in the case where “Update” has been selected. Then, the processor 201 ends the member-service process in FIG. 11. In detail, as shown in FIG. 5, the process unit 2008 executes the point process for only the member identified by the member information received later. The process unit 2008 executes this process as well as the purchase-history process for all members identified by the received member information.

Meanwhile, in the case where it is determined in Step S33 that “A=1” is not stored in the handling-information area 205 (No in Step S33), the process of the processor 201 proceeds to Step S35. In Step S35, the processor 201 determines whether or not “A=2” is stored in the handling-information area 205 of the RAM 203. In the case where it is determined that “A=2” is stored in the handling-information area 205 (Yes in Step S35), the process of the processor 201 proceeds to Step S36. In Step S36, the process unit 2008 of the processor 201 refers to the handling-process area 214 shown in FIG. 5, and executes the member-service process for the target member in the case where “Add” has been selected. Then, the processor 201 ends the member-service process in FIG. 11. In detail, as shown in FIG. 5, the process unit 2008 executes the point process and the purchase-history process for all members identified by the received member information. In this case, the store is capable of freely setting the method of giving points to a plurality of members as described above.

Meanwhile, in Step S35, in the case where it is determined that “A=2” is not stored in the handling-information area 205 of the RAM 203 (No in Step S35), the process of the processor 201 proceeds to Step S37. In Step S37, the processor 201 determines whether or not “A=3” is stored in the handling-information area 205. In the case where it is determined that “A=3” is stored in the handling-information area 205 (Yes in Step S37), the process of the processor 201 proceeds to Step S38. In Step S38, the process unit 2008 of the processor 201 refers to the handling-process area 214 shown in FIG. 5, and executes the member-service process for the target member in the case where “Cancel” has been selected. Then, the processor 201 ends the process. In detail, as shown in FIG. 5, the process unit 2008 executes the point process for only the member identified by the previously received member information. The process unit 2008 executes this process as well as the purchase-history process for all members identified by the received member information.

Meanwhile, in the case where it is determined in Step S37 that “A=3” is not stored in the handling-information area 205 of the RAM 203 (No in Step S37), the processor 201 ends the member-service process in FIG. 11. That is, the first reception unit 2005 of the processor 201 determines that member information has not been received during the reading period or that the received member information has been canceled, and does not execute the point process and the purchase-history process. Thus, the processor 201 ends the member-service process.

As described above, in the POS terminal 2 according to this embodiment, the processor 201 of the controller 200 has the functions of the first reception unit 2005 that receives member information for identifying a member and the process unit 2008 that executes a process relating to a service to be provided to the member identified by the member information received by the first reception unit 2005. Further, the processor 201 of the controller 200 has the function of the output control unit (instruction unit 2009) that outputs, in the case where the first reception unit 2005 receives a plurality of pieces of different member information for one transaction, information for causing a customer to select a method of handling the member information for the process of the process unit 2008 of the processor 201. For this reason, in the POS terminal 2 according to this embodiment, a plurality of pieces of member information can be received for one transaction, and a method of handling the member information for the member-service process can be input. Therefore, according to this embodiment, the member-service process can be executed on a plurality of members for one transaction. Further, in the POS terminal 2 according to this embodiment, in the case where only one piece of member information is received for one transaction, there is no need to input a method of handling the member information. Therefore, according to this embodiment, the operation can be simplified and the operability can be improved.

Further, the POS terminal 2 according to this embodiment displays, on the display device, a selection screen in which a method of handling the member information can be selected. For this reason, according to this embodiment, it is possible to easily select a method of handling the member information. In addition, the POS terminal 2 according to this embodiment displays, in the case where the first reception unit 2005 receives a plurality of pieces of member information, the selection screen on the customer display 24 during the reading period. For this reason, according to this embodiment, since the customer can immediately input a method of handling the member information, it is possible to efficiently perform accounting.

Further, the customer display 24 displays a selection screen every time the first reception unit 2005 receives member information during the reading period, and the first selection screen differs from the second and subsequent selection screens. Specifically, the four selection buttons 2412 to 2415 of “Update”, “Add”, “Cancel”, and “Cancel all” are displayed on the first selection screen, and the three selection buttons 2413 to 2415 of “Add”, “Cancel”, and “Cancel all” are displayed on the second selection screen. In one transaction, the customer display 24 displays the selection screens a plurality of times in the case where the first reception unit 2005 receives three or more pieces of member information. That is, when the customer display 24 displays the selection screen at the second or subsequent time, a plurality of pieces of member information is stored in the member-information area 204 of the RAM 203. In this case, when the “Update” selection button 2413 is displayed, it is difficult for the customer selecting the selection button 2413 to understand which member information stored in the member-information unit 204 is to be updated. Therefore, the operability can be improved by not displaying the “Update” button on the selection screen displayed at the second or subsequent time in one transaction.

In addition, the process unit 2008 of the processor 201 executes a different process in accordance with the method of handling the member information indicated by the information received by the second reception unit 2006. For example, as shown in FIG. 5, the process unit 2008 causes the targets of the point process and the purchase-history process to be different from each other in accordance with the selected method of handling the member information. Specifically, in the case where the method of handling the member information received later by the first reception unit 2005 is “Add”, the process unit 2008 executes both the point process and the purchase-history process for all members identified by the received member information. Meanwhile, in the case where the method of handling the member information received later by the first reception unit 2005 is “Update”, the process unit 2008 executes the point process for only the member identified by the member information received later, but executes the purchase-history process for all members identified by the received member information. In other words, even though the method of handling the member information is “Update”, the member information is not “updated” but “added” in the case of the purchase-history process. As a result, the store is capable of grasping more purchase histories of the customer, which are useful for sales promotion. The process unit 2008 executes a different process in accordance with the method of handling the member information as described above, so that information useful for the store can be acquired.

Note that in the above-mentioned embodiment, the control program executed by the POS terminal 2 may be configured to be recorded on a computer-readable recording medium such as a CD-ROM and provided. Further, the control program executed by the POS terminal 2 according to the above-mentioned embodiment may be provided by being stored in a computer connected to a network such as the Internet and being downloaded through a network. Alternatively, the control program may be configured to be provided through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An accounting apparatus that executes an accounting process relating to transaction data of a commodity for which sales registration has been performed in one transaction, comprising;
a reader that reads, from a recording medium of a customer, member information of the customer for identifying a member in the one transaction;
an input/output device that outputs information regarding a plurality of handling methods for the member information read by the reader and receives selection of one of the plurality of handling methods;
a memory that stores the member information and the information regarding the plurality of handling methods; and
a processor that
receives the read member information and stores the received information in the memory,
causes the input/output device to output the information regarding the plurality of handling methods on a condition that the number of pieces of member information related to the one transaction stored in the memory after the reading of the member information by the reader is two or more,
stores, in the memory, the information regarding the handling method selected via the input/output device, and
executes, in accordance with the information regarding the handling method stored in the memory after the accounting process, a service process for providing a service to the customer of the member identified by the member information stored in the memory.

2. The accounting apparatus according to claim 1, wherein
the input/output device is a display including a touch panel, and
the display displays a selection screen for receiving selection of one of a plurality of handling methods for the member information read by the reader.

3. The accounting apparatus according to claim 2, further comprising
a storage device that stores display data corresponding to the number of pieces of member information stored in the memory to display the selection screen on the display.

4. The accounting apparatus according to claim 3, wherein
the processor
displays, on a condition that the number of pieces of member information stored in the memory after the reading of the member information by the reader is two or more, the selection screen corresponding to the number of pieces of member information on the display in accordance with the display data stored in the storage device, and
stores, in the memory, the information regarding the handling method selected via the selection screen.

5. The accounting apparatus according to claim 3, wherein
the processor displays the selection screen on the display each time the read member information is received.

6. The accounting apparatus according to claim 5, wherein
the storage device stores display data for a selection screen to be displayed for the first time and display data for a selection screen to be displayed for the second and subsequent times.

7. The accounting apparatus according to claim 5, wherein
the processor receives instruction information for instructing the handling method via the selection screen of the display, and
the instruction information includes information indicating updating of the member information, addition of the member information, and cancelling of the member information.

8. The accounting apparatus according to claim 7, wherein
the processor switches content of the service process for providing the service in accordance with the handling method instructed by the received instruction information.

9. A registration apparatus that executes a sales registration process of a commodity in one transaction and outputs transaction data of the commodity for which the sales registration process has been performed, comprising;
a reader that reads, from a recording medium of a customer, member information of the customer for identifying a member in the one transaction;
an input/output device that outputs information regarding a plurality of handling methods for the member information read by the reader and receives selection of one of the plurality of handling methods;
a memory that stores the member information and the information regarding the plurality of handling methods; and
a processor that
receives the read member information and stores the received information in the memory,
causes the input/output device to output the information regarding the plurality of handling methods on a condition that the number of pieces of member information related to the one transaction stored in the memory after the reading of the member information by the reader is two or more,
stores, in the memory, the information regarding the handling method selected via the input/output device, and
executes, in accordance with the information regarding the handling method stored in the memory after the accounting process, a service process for providing a service to the customer of the member identified by the member information stored in the memory.

10. A control method for an accounting apparatus that executes an accounting process relating to transaction data of a commodity for which sales registration has been performed in one transaction, comprising;
reading, from a recording medium of a customer, member information of the customer for identifying a member in the one transaction;
storing the read member information in the memory;
outputting, on a condition that the number of pieces of member information related to the one transaction stored in the memory after the reading of the member information is two or more, information regarding a plurality of handling methods for the member information;
receiving information regarding selection of one of the plurality of handling methods from the information regarding the plurality of handling methods;
storing, in the memory, the information regarding the selected handling method; and
executes, in accordance with the information regarding the handling method stored in the memory after the accounting process, a service process for providing a service to the customer of the member identified by the member information stored in the memory.
